(19) United States
(12) Patent Application Publication
(10) Pub. No.: US 2010/0149689 A1
(43) Pub. Date: Jun. 17, 2010

(54) Thin film magnetic head having a pair of magnetic layers whose magnetization is controlled by shield layer including amorphous layer

(75) Inventors: Yoshihiro Tsuchiya, Tokyo (JP); Tsutomu Chou, Tokyo (JP); Daisuke Miyauchi, Tokyo (JP); Shinji Hara, Tokyo (JP); Takahiko Machita, Tokyo (JP); Hironobu Matsuzawa, Tokyo (JP)

Correspondence Address: POSZ LAW GROUP, PLC, 12040 SOUTH LAKES DRIVE, SUITE 101, RESTON, VA, 20191, US

(73) Assignee: TDK CORPORATION, Tokyo (JP)

(21) Appl. No.: 12/314,464

(22) Filed: Dec. 11, 2008

(51) Int. Cl. G11B 5/60; G11B 5/33

(52) U.S. Cl. 360/234.3; 360/313; G9B/5.104; G9B/5.229

(57) ABSTRACT

A thin film magnetic head includes a magnetoresistance (MR) layered body that has first and second magnetic layers whose magnetization direction are changed according to an external magnetic field, a nonmagnetic middle layer and where the first magnetic layer, the nonmagnetic middle layer and the second magnetic layer are disposed in a manner of facing each other in respective order, first and second shield layers that are disposed in a manner of sandwiching the MR-stack in the film surface orthogonal direction of the MR-stack facing the first magnetic layer and the second magnetic layer, respectively, and that also serve as an electrode for applying a sense current to the film surface orthogonal direction of the MR-stack; and a bias magnetic field application means that is disposed on an opposite surface of an air bearing surface (ABS) of the MR-stack, and that applies a bias magnetic field to the MR-stack in the direction orthogonal to the ABS. The first shield layer has a first exchange coupling magnetic field (ECMF) application layer that is disposed in a manner of facing the first magnetic layer, and that transmits to the first magnetic layer an exchange coupling magnetic field in the direction in parallel with the ABS, and that includes an amorphous layer, and has a first antiferromagnetic layer that is disposed on a rear surface of the first ECMF application layer viewed from the first magnetic layer in a manner of facing the first ECMF application layer, and that is exchange-coupled with the first ECMF application layer. The second shield layer has a second exchange coupling magnetic field (ECMF) application layer that is disposed in a manner of facing the second magnetic layer, and that transmits to the second magnetic layer the exchange coupling magnetic field in a direction in parallel with the ABS; and a second antiferromagnetic layer that is disposed on a rear surface of the second ECMF application layer viewed from the second magnetic layer, and that is exchange-coupled with the second ECMF application layer.

### BACKGROUND OF THE INVENTION

1. Field of the Invention

The present invention relates to a thin film magnetic head, and particularly relates to a device structure of the thin film magnetic head comprising a pair of magnetic layers whose magnetization direction is changed with regard to an external magnetic field.

2. Description of the Related Art

In association with high recording density on a hard disc drive (HDD), a head with high sensitivity and high output is in demand. As the head satisfying this demand, a spin valve head has been invented. The spin valve head is equipped with a pair of ferromagnetic layers via a nonmagnetic middle layer. An antiferromagnetic layer is arranged in a manner of facing one of the ferromagnetic layers, and exchange coupling between the one ferromagnetic layer and the antiferromagnetic layer results in fixation of the magnetization direction of the ferromagnetic layer. In the other ferromagnetic layer, the magnetization direction is freely rotated according to an external magnetic field. Thus, the ferromagnetic layer whose magnetization direction is freely rotated according to the external magnetic field is referred to as a free layer, as well. A change in electrical resistance of the spin valve head is realized by a change in a relative angle of the magnetization directions in these two ferromagnetic layers. The pair of the ferromagnetic layers are sandwiched between a pair of the shield layers. The shield layers prevent the external magnetic field from adjacent bits on the same track of a recording medium from being applied to the pair of ferromagnetic layers.

The exchange coupling between the antiferromagnetic layer and the ferromagnetic layer is one of the essential characteristics in the spin valve head. However, if high recording density further progresses and a read gap (width in a medium traveling direction upon reading a signal of a moving medium by a magnetic head; correlated with the thickness of a film sandwiched between the shield layers) becomes approximately 20 nm, there is no room to include an antiferromagnetic layer within the read gap. Then, a technology to control the magnetization direction of the ferromagnetic layer using another method and to change a relative angle formed with the magnetization directions of two ferromagnetic layers becomes required. In the specification of U.S. Pat. No. 7,035,062, a thin film magnetic head having two free layers whose magnetization directions are changed according to an external magnetic field and a nonmagnetic middle layer sandwiched between these free layers is disclosed. The two free layers are exchange-coupled by RKKY (Rudermann, Kittel, Kasuya, Yoshida) interaction via a nonmagnetic middle layer. In a state where no magnetic field is applied at all (hereafter, this state is referred to as a magnetic field-free state), the two free layers are magnetized antiparallel to each other. A bias magnetic layer is disposed on the rear surfaces of the two free layers and the nonmagnetic middle layer viewed from an air bearing surface (ABS), respectively. Herein, the ABS is a surface of the thin film magnetic head opposite to the recording medium on the occasion of reading a signal of the recording medium. The bias magnetic layer applies a bias magnetic field in the direction orthogonal to the ABS to the two free layers. The magnetization directions of the two free layers form a constant relative angle with the magnetic field from the bias magnetic layer. In this state, when an external magnetic field in the direction orthogonal to the ABS is provided from the recording medium, the magnetization directions of the two free layers are changed. As a result, a relative angle formed with the magnetization directions of the two free layers is changed, and electric resistance of a sense current is changed. The thin film magnetic head can detect the external magnetic field using this characteristic. In the film configuration using the two free layers as described above, because an anti-ferromagnetic layer is unnecessary, the film configuration is simplified and the read gap is easily reduced. Furthermore, in this specification, “parallel” means that the magnetization directions are parallel with each other and oriented in the same directions, and “antiparallel” means that the magnetization directions are parallel with each other, but oriented in opposite directions.

However, in the thin film magnetic head with a system where two free layers are magnetically coupled due to the RKKY interaction, materials to be usable as the nonmagnetic middle layer are limited, and an improvement of a rate of magnetoresistance change (MR-ratio) cannot be expected. Then, another technology to magnetize the two free layers to directions in antiparallel to each other becomes required.

Further, since the nonmagnetic middle layer and the free layers are thin films, they are susceptible to surface roughness. When the surface roughness of the nonmagnetic middle layer becomes greater, sections where the distance between the two free layers becomes closer is increased. With this design, an interlayer coupling magnetic field to be generated by the roughness (surface roughness) is increased, and it becomes difficult for the two magnetic layers to be antiparallel to each other. In addition, because portions of the two free layers make contact with each other and they are magnetically and electrically short-circuited, current components contributing to the magnetoresistance effect is decreased and the MR-ratio is reduced. Therefore, it is also necessary to reduce the surface roughness of the nonmagnetic middle layer and the free layers.

### SUMMARY OF THE INVENTION

The present invention targets a thin film magnetic head having an MR-stack where a first magnetic layer (free layer) whose magnetization direction is changed according to an external magnetic field, a nonmagnetic middle layer and a second magnetic layer (free layer) whose magnetization direction is changed according to the external magnetic field are disposed in a manner facing each other in respective order, and bias magnetic field application means that is disposed on the opposite surface of the ABS in the MR-stack and that applies a bias magnetic field whose direction is orthogonal to the ABS to the MR-stack. The objective of the present invention is to provide a thin film magnetic head that can obtain a high rate of magnetization change by controlling the magnetization directions of the two magnetic layers to be antiparallel to each other in a magnetic field-free state without depending upon the magnetic interaction between these magnetic layers, and where the read gap is easily reduced. Further, the other objective of the present invention is to provide a thin film magnetic head where the surface roughness of the free layers and the nonmagnetic middle layer is reduced and the MR-ratio is improved.

The thin film magnetic head relating to one embodiment of the present invention includes: an MR-stack that has a first magnetic layer whose magnetization direction is changed according to an external magnetic field, a nonmagnetic middle layer and a second magnetic layer whose magnetization direction is changed according to an external magnetic field, and where the first magnetic layer, the nonmagnetic middle layer and the second magnetic layer are disposed in a manner of facing each other in respective order, first and second shield layers that are disposed in a manner of sandwiching the MR-stack in the film surface orthogonal direction of the MR-stack facing the first magnetic layer and the second magnetic layer, respectively, and that also serve as an electrode applying a sense current to the film surface orthogonal direction of the MR-stack; and a bias magnetic field application means that is disposed on an opposite surface of an air bearing surface (ABS) of the MR-stack, and that applies a bias magnetic field in a direction orthogonal to the ABS to the MR-stack. The first shield layer has a first exchange coupling magnetic field application layer (hereinafter, first ECMF application) that is disposed in a manner of facing the first magnetic layer, and that transmits an exchange coupling magnetic field in parallel with the ABS to the first magnetic layer, and that includes an amorphous layer, and a first antiferromagnetic layer that is disposed on the rear surface of the first ECMF application layer viewed from the first magnetic layer, and that is exchange-coupled with the first ECMF application layer. The second shield layer has a second exchange coupling magnetic field application layer that is disposed in a manner of facing the second magnetic layer, and that transmits an exchange coupling magnetic field in parallel with the ABS to the second magnetic layer, and a second antiferromagnetic layer that is disposed on the rear surface of the second exchange coupling magnetic field application layer viewed from the second magnetic layer, and that is exchange-coupled with the second exchange coupling magnetic field application layer. The first magnetic layer and the second magnetic layer are magnetized so as to have the the magnetization direction being antiparallel to each other in the state where no external magnetic field is applied.

In the thin film magnetic head configured as mentioned above, the exchange coupling magnetic fields from the first and second exchange coupling magnetic field application layers whose magnetization directions are strongly fixed due to the exchange coupling with the first and second antiferromagnetic layers is transmitted to the first and second magnetic layers, respectively. The exchange coupling magnetic field from the first ECMF application layer and the exchange coupling magnetic field from the second exchange coupling magnetic field application layer can be made antiparallel to each other, and the first and second magnetic layers are magnetized to be antiparallel to each other in the magnetic field-free state. However, in actuality, since a bias magnetic field in the direction orthogonal to the ABS is received from the bias magnetic field application means, the first and second magnetic layers are magnetized to the intermediate state between antiparallel and parallel. When the external magnetic field from the recording medium is applied having this state as an initial magnetized state, because the relative angle formed with the magnetization directions of the first and second magnetic layers is changed according to the magnitude and direction of the external magnetic field, it becomes possible to detect the external magnetic field utilizing the magnetoresistant effect.

In addition, since the first and second antiferromagnetic layers and the first and second exchange coupling magnetic field application layers have a function as a shield layer, respectively, they also contribute to the reduction in the read gap. The present invention is characterized in that the shield layer that has not been magnetically coupled with the magnetic layer conventionally is magnetically coupled with the magnetic layer.

In addition, the first ECMF application layer includes an amorphous layer. Since the amorphous layer does not have a crystal structure, the surface roughness of the amorphous layer is reduced. Therefore, the surface roughness in each layer of the MR-stack layered on the amorphous layer, especially in that of the nonmagnetic middle layer, is reduced. As a result, the MR-ratio of the thin film magnetic head is improved.

Thus, a thin film magnetic head that enables the obtainment of a high MR-ratio, and where the read gap is easily reduced can be provided.

The above-mentioned and other objectives, characteristics and advantages of the present invention will be clear from the explanation hereafter with reference to attached drawings illustrating the present invention.

### BRIEF DESCRIPTION OF THE DRAWINGS

FIG. 1 is a side cross-sectional view of the thin film magnetic head relating to one embodiment of the present invention;

FIG. 2A is a side view of a reading part of the thin film magnetic head viewed from 2A-2A direction of FIG. 1;

FIG. 2B is a cross sectional view of the reading part of the thin film magnetic head viewed from the same direction as FIG. 1;

FIGS. 3A-3D are conceptual diagrams showing a principle of operation of the thin film magnetic head shown in FIG. 1;

FIG. 4 is a pattern diagram showing the relationship between magnetic field intensity to be applied to the first and second magnetic layers and a signal output;

FIG. 5 is a side view of a reading part of a thin film magnetic head in a modified example of the present invention viewed from ABS;

FIG. 6 is a side view of a reading part of a thin film magnetic head in another modified embodiment of the present invention viewed from ABS;

FIG. 7 is a conceptual diagram showing configuration of a thin film magnetic head and a principle of operation in another modified embodiment of the present invention;

FIG. 8 is a graph showing a relationship between a ratio of thickness of an amorphous layer to thickness of a first ferromagnetic layer and a MR-ratio;

FIG. 9 is a plan view of a wafer relating to the production of the thin film magnetic head of the present invention;

FIG. 10 is a perspective view of a slider of the present invention;

FIG. 11 is a perspective view of a head arm assembly including a head gimbal assembly where the slider of the present invention is incorporated;

FIG. 12 is a side view of the head arm assembly where the slider of the present invention is incorporated; and

FIG. 13 is a plan view of a hard disk device where the slider of the present invention is incorporated.

### DETAILED DESCRIPTION OF THE INVENTION

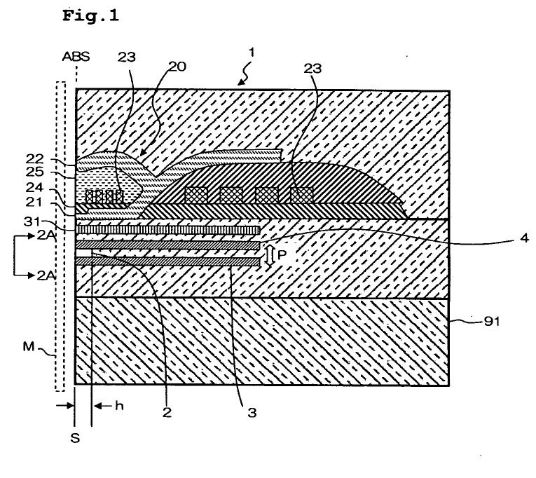

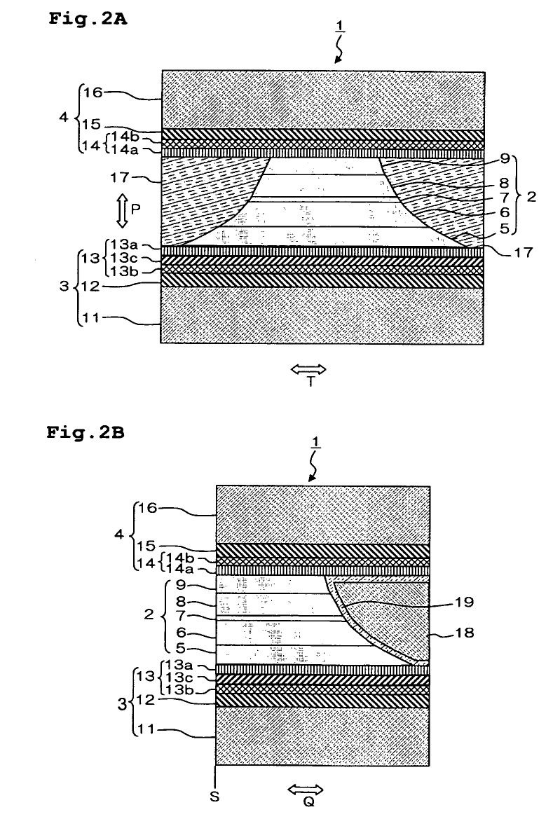

Hereafter, a thin film magnetic head relating to one embodiment of the present invention will be described with reference to the drawings. FIG. 1 is a side cross-sectional view of the thin film magnetic head in this embodiment. FIG. 2A is a side view of the reading part of the thin film magnetic head viewed from 2A-2A direction of FIG. 1, i.e., from the ABS; and FIG. 2B is a cross sectional view of the reading part of the thin film magnetic head viewed from the same direction as FIG. 1. The ABS S is an opposing surface of a thin film magnetic head 1 against a recording medium M.

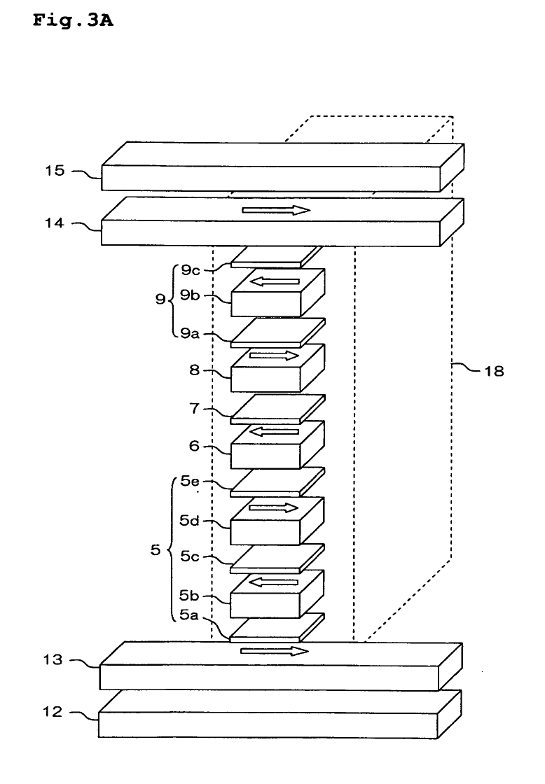

The thin film magnetic head 1 has an MR-stack 2, and first and second shield layers 3 and 4 disposed in a manner of sandwiching the MR-stack 2 in a film surface orthogonal direction P of the MR-stack 2. Table 1 shows film configurations of the MR-stack and the first and second shield layers 3 and 4. In the table, the film configurations are described from bottom to top in lamination order from the first shield layer 3 toward the second shield layer 4. Furthermore, the magnetization direction shown in the table corresponds to that in FIG. 3A.

TABLE 1

| | | | | Thickness | Magnetization |
|---|---|---|---|---|---|
| Layer configuration | | | | [nm] | direction |
| Second | Second main shield layer 16 | | NiFe layer | 1000 | |
| shield | Second antiferromagnetic layer 15 | | IrMn layer | 5.0 | |
| layer 4 | Second exchange coupling magnetic | | CoFe layer | 1 | → |
| | field application layer 14 | | 14b | | |
| | | | NiFe layer | 79 | |
| | | | 14a | | |
| MR-stack 2 | Second magnetic linkage layer 9 | | Ru layer 9c | 0.8 | |
| | | | CoFe layer | 1 | ← |
| | | | 9b | | |
| | | | Ru layer 9a | 0.8 | |
| | Second magnetic layer 8 | | CoFe layer | 4 | → |
| | Nonmagnetic middle layer 7 | | ZnO layer | 2 | |
| | First magnetic layer 6 | | CoFe layer | 4 | ← |
| | First magnetic linkage layer 5 | | Ru layer 5e | 0.8 | |
| | | | CoFe layer | 1 | → |
| | | | 5d | | |
| | | | Ru layer 5c | 0.8 | |
| | | | CoFe layer | 1 | ← |
| | | | 5b | | |
| | | | Ru layer 5a | 0.8 | |
| First shield | First ECMF | First ferromagnetic | NiFe layer | 69 | → |
| layer 3 | application | layer 13a | | | |
| | layer 13 | Amorphous layer | CoFeB layer | 10 | |
| | | 13c | | | |
| | | Second | CoFe layer | 1 | |
| | | ferromagnetic layer | | | |
| | | 13b | | | |

| | | |
|---|---|---|
| First antiferromagnetic layer 12 | IrMn layer | 5.0 |
| First main shield layer 11 | NiFe layer | 1000 |

With reference to FIG. 2A and Table 1, the MR-stack 2 has a first magnetic layer 6 whose magnetization direction is changed according to an external magnetic field, a nonmagnetic middle layer 7 and a second magnetic layer 8 whose magnetization direction is changed according to the external magnetic field is changed. The first magnetic layer 6, the nonmagnetic middle layer 7 and the second magnetic layer 8 are disposed in a manner of facing each other in respective order. Further, a first magnetic linkage layer 5 is disposed adjacent to the first magnetic layer 6, and a second magnetic linkage layer 9 is disposed adjacent to the second magnetic layer 8.

The first magnetic layer 6 and the second magnetic layer 8 are each formed with a CoFe layer, and the nonmagnetic middle layer 7 is formed with a ZnO layer. The first magnetic layer 6 and the second magnetic layer 8 may be formed with a NiFe layer or a CoFeB layer. The first magnetic layer 6 can be formed with a two-layer film of NiFe/CoFe, and the second magnetic layer 8 can be formed with a two-layer film of CoFe/NiFe. In this specification, the description of “A/B/C . . . ” indicates that films A, B, C . . . are layered in respective order. In other words, it is preferable that a CoFe layer faces the nonmagnetic middle layer 7 (ZnO layer) when each of the first magnetic layer 6 and the second magnetic layer 8 is a two-layer film.

The nonmagnetic middle layer 7 may be formed with MgO, Al₂O₃, AlN, TiO₂ or NiO. When metal or a semiconductor, such as ZnO, is used as the nonmagnetic middle layer 7, the thin film magnetic head 1 functions as a CPP (Current Perpendicular to the Plane)-GMR (Giant Magneto-Resistance) element. Further, when an insulator, such as MgO, is used as the nonmagnetic middle layer 7, the thin film magnetic head 1 functions as a tunneling magneto-resistance (TMR) element.

The first magnetic linkage layer 5 is disposed between the first magnetic layer 6 and the first ECMF application layer 13 within the first shield layer 3. The first magnetic linkage layer 5 has a function to transmit the exchange magnetic field from the first ECMF application layer 13 to the first magnetic layer 6 as described in detail hereafter. The first magnetic linkage layer 5 has a layered constitution of five layers, Ru layer/CoFe layer/Ru layer/CoFe layer/Ru layer in this embodiment.

Similarly, the second magnetic linkage layer 9 is disposed between the second magnetic layer 8 and the second exchange coupling magnetic field application layer 14 within the second shield layer 4. The second magnetic linkage layer 9 has a function to transmit the exchange magnetic field from the second exchange coupling magnetic application layer 14 to the second magnetic layer 8 as described in detail hereafter. The second magnetic linkage layer 9 has a layered constitution of three layers, Ru layer/CoFe layer/Ru layer in this embodiment.

The first and second shield layer 3 and 4 have a function to prevent the external magnetic field from an adjacent bit on the same track of the recording medium from applying to the MR-stack 2. Further, the first shield layer 3 as well as the second shield layer 4 also serve as an electrode for applying a sense current in the film surface orthogonal direction P of the MR-stack 2.

The first shield layer 3 is disposed at the side facing the first magnetic layer 6 via the first magnetic linkage layer 5. The first shield layer 3 has a first ECMF application layer 13, a first antiferromagnetic layer 12 disposed in a manner of facing the first ECMF application layer 13 on the rear surface of the ECMF application layer 13 viewed from the first magnetic layer 6, and a first main shield layer 11 disposed on the rear surface of the first antiferromagnetic layer 12 viewed from the first magnetic layer 6.

The first ECMF application layer 13 has a first ferromagnetic layer 13a facing the first magnetic linkage layer 5 and a second ferromagnetic 13b facing the first antiferromagnetic layer 12. In addition, the first ECMF application layer 13 includes an amorphous layer 13c sandwiched between the first ferromagnetic layer 13a and the second ferromagnetic layer 13b. In this embodiment, the first ferromagnetic layer 13a is a NiFe layer, and the second ferromagnetic layer 13b is a CoFe layer. Furthermore, the second ferromagnetic layer 13b may be a NiFe layer or a two-layer configuration of NiFe/CoFe.

The amorphous layer 13c is preferably made of an amorphous alloy having ferromagnetism. As such amorphous, a CoFeB layer or a CoZrTa layer is applicable. Because the amorphous layer 13c has the ferromagnetism, the first ferromagnetic layer 13a and the second ferromagnetic layer 13b are strongly and magnetically coupled.

Since the amorphous alloy does not have a crystal structure, even if the amorphous layer 13c is deposited on the rough surface, the surface roughness of the amorphous layer 13c is reduced. Therefore, the amorphous layer 13c has a function to reduce the surface roughness of each layer in the MR-stack 2. The reduction of the surface roughness in each layer of the MR-stack 2 results in an increase of the stability of the thin film magnetic head 1, and an improvement of the MR-ratio.

When there is no amorphous layer 13c, every time each layer of the first shield layer 3 is deposited, the surface roughness of each layer is increased. It appears that this is caused by grain growth in the film formation process of the ECMF application layer 13 or the like.

The first antiferromagnetic layer 12 is made of IrMn, and is strongly exchange-coupled with the adjacent second ferromagnetic layer 13b. The first antiferromagnetic layer 12 can be formed from an alloy, such as Fe—Mn, Ni—Mn, Pt—Mn or Pd—Pt—Mn, in addition to IrMn, or from a combination of these alloys including IrMn. The first main shield layer 11 is formed with a NiFe layer, and blocks an external magnetic field from an adjacent bit on the same track of the recording medium M. The configuration of the first main shield layer 11 is the same as a well-known shield layer, and in general, has 1 μm-2 μm of thickness (1 μm of thickness in the configuration shown in the table). The first main shield layer 11 is thicker than the first ECMF application layer 13 and the first antiferromagnetic layer 12. Further, since the first main shield layer 11 has a multi-magnetic domain structure, it has high permeability. Consequently, the first main shield layer 11 effectively functions as a shield.

The second shield layer 4 is disposed at the side facing the second magnetic layer 8 via the second magnetic linkage layer 9. The second shield layer 4 has the second exchange coupling magnetic field application layer 14, the second antiferromagnetic layer 15 disposed in a manner of facing the second exchange coupling magnetic field application layer 14 on the rear surface of the second exchange coupling magnetic field application layer 14 viewed from the second magnetic layer 8, and the second main shield layer 16 disposed on the rear surface of the second antiferromagnetic layer 15 viewed from the second magnetic layer 8. The second exchange coupling magnetic field application layer 14 has a two-layer configuration of the CoFe layer 14b disposed in a manner of facing the second antiferromagnetic layer 15 and the NiFe layer 14a disposed in a manner of facing both the CoFe layer 14b and the second exchange coupling transmission 9. The second antiferromagnetic layer 15 is made of IrMn, and is strongly exchange-coupled with the adjacent CoFe layer 14b. The second antiferromagnetic layer 15 can be formed from an alloy, such as Fe—Mn, Ni—Mn, Pt—Mn or Pd—Pt—Mn, other than IrMn. The second main shield layer 16 is formed with a NiFe layer, and blocks an external magnetic field from the adjacent bit on the same track of the recording medium. The configuration of the second main shield layer 16 is the same as that of a well-known shield layer, and has 0.5 μm-1.0 μm of thickness in general. The second main shield layer 16 is thicker than the second exchange coupling magnetic field application layer 14 and the second antiferromagnetic layer 15. Further, the second main shield layer 16 has a multi-magnetic domain structure, and it has high permeability. Consequently, the second main shield layer 16 effectively functions as a shield.

In the configuration shown in Table 1, the first and the second antiferromagnetic layers 12 and 15 of the first and second shield layers 3 and 4 face the CoFe layer of the first and second ECMF application layers 13 and 14, respectively. This is to secure a large exchange coupling intensity with the first and second antiferromagnetic layers 12 and 15.

If the exchange coupling intensity becomes smaller, it becomes difficult to strongly fix the magnetization directions of the first and second ECMF application layers 13 and 14 by the first and second antiferromagnetic layers 12 and 15. Furthermore, if the large exchange coupling intensity can be secured, the NiFe layer may be disposed instead of the CoFe layer facing the first and second antiferromagnetic layers 12 and 15.

The NiFe layer disposed as the first antiferromagnetic layer 13a and the NiFe layer 14a of the second exchange coupling magnetic field application layer 14 improve a soft magnetic property of the shield layers 3 and 4 and effectively demonstrate the function as a shield layer.

Further, a nonmagnetic layer (not shown), such as Cu, may be inserted between the second antiferromagnetic layer 15 and the second main shield layer 16. The thickness of the nonmagnetic layer is approximately 1 nm in the case of Cu. The insertion of the nonmagnetic layer results in easy realization of the multi-magnetic domain, and shield performance of the main shield layer 16 to the external magnetic field is improved. However, in the case of not arranging the nonmagnetic layer, noises due to the movement of the magnetic domain in the shield layer 16 rarely occur. Therefore, whether or not the nonmagnetic layer is inserted depends upon a design determination.

In addition, a buffer layer (not shown) may be inserted between the first antiferromagnetic layer 12 and the first main shield layer 11. The buffer layer is formed with a two-layer film of, for example, Ru/Ta. The buffer layer is disposed as a substrate of the layered film.

With reference to FIG. 2A, an insulating layer 17 made of Al₂O₃ is formed at both sides of track width direction T (direction in parallel to ABS S and orthogonal to the film surface orthogonal direction P) of the MR-stack 2. The arrangement of the insulating layer 17 allows concentrating a sense current flowing in the film surface orthogonal direction P of the MR-stack 2 to the MR-stack 2. The insulating layer 17 may be formed with film thickness required for insulation at the side of the MR-stack 2. Further, a conductive film may exist outside the insulating layer 17 viewed from the MR-stack 2. However, even when the conductive film exists, the first shield layer 3 and the second shield layer 4 need to be insulated.

As shown in FIG. 2B, a bias magnetic field application means 18 is disposed on the surface of the MR layered 2 opposite from the ABS S via the insulating layer 19 made of Al₂O₃. The bias magnetic field application means 18 is a hard magnetic film made of CoPt, CoCrPt or the like, and applies the bias magnetic field in the direction Q orthogonal to ABS S to the MR-stack 2. The insulating layer 19 prevents the sense current from flowing into the bias magnetic field application means 18.

With reference to FIG. 1, a writing part 20 is disposed above the second shield layer 4 via an interelement shield layer 31 formed using a sputtering method. The writing part 20 has a configuration for so-called perpendicular magnetic recording. The magnetic pole layer for writing is composed of a main magnetic pole layer 21 and an auxiliary magnetic layer 22. These magnetic pole layers 21 and 22 are formed using, for example, a flame plating method. The main magnetic pole layer 21 is made of FeCo, and is exposed in the direction substantially orthogonal to the ABS S on the ABS S. A coil layer 23 extending over a gap layer 24 made of an insulating material is wound around the main magnetic pole layer 21, and a magnetic flux is induced to the main magnetic pole layer 21 by the coil layer 23. The coil layer 23 is formed using the flame plating method. This magnetic flux is led into the inside of the main magnetic pole layer 21, and extends toward the recording medium from the ABS S. The main magnetic pole layer 21 is narrowed not only to the film surface orthogonal direction P in the vicinity of the ABS S but also in the track width direction T (orthogonal to the plane of the drawing in FIG. 1; see FIG. 2A, as well), and a minute and strong writing magnetic field corresponding to the high density of recording is generated.

The auxiliary magnetic pole layer 22 is a magnetic layer magnetically coupled with the main magnetic pole layer 21. The auxiliary magnetic pole layer 22 is a magnetic pole layer formed with an alloy made from two or three layers of Ni, Fe and Co with approximately 0.01 μm-approximately 0.5 μm of thickness. The auxiliary magnetic pole layer 22 is branched from the main magnetic pole layer 21, and is on the opposite side of the main magnetic pole layer 21 via the gap layer 24 and the coil insulating layer 25 at the ABS S side. The terminal of the auxiliary magnetic pole layer 22 at the ABS S side forms a trailing shield part whose layer cross section is wider than any other portions of the auxiliary magnetic pole layer 22. The arrangement of such auxiliary magnetic pole layer 22 results in a more precipitous magnetic field gradient between the auxiliary magnetic pole layer 22 and the main magnetic pole layer 21 in the vicinity of the ABS S. As a result, signal output jitter becomes smaller and an error rate at the time of reading can be smaller.

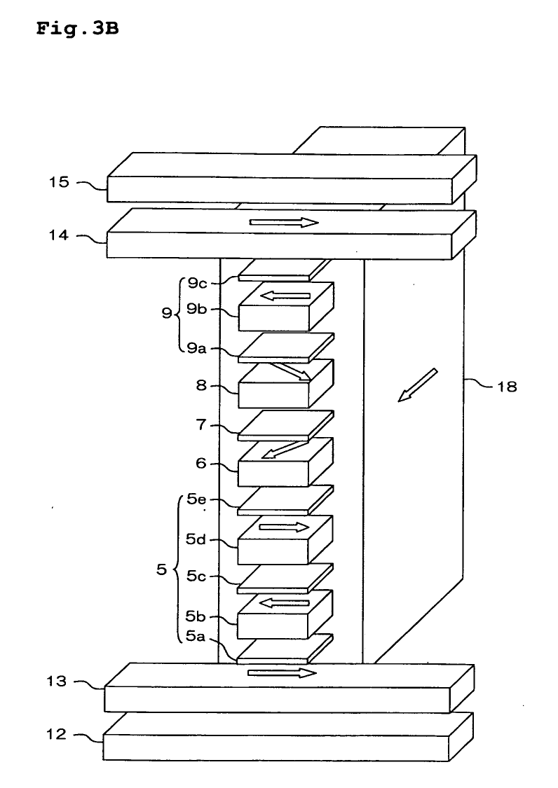

Next, with reference to FIGS. 3A to 3D and FIG. 4, a principle of operation to read magnetic information recorded in the recording medium by the thin film magnetic head in this embodiment will be described. First, a magnetic field-free state where an external magnetic field and a bias magnetic field from the bias magnetic field application means 18 are not applied is assumed. FIG. 3A is a pattern diagram showing a magnetized state of the MR-stack and the shield layer in such virtual magnetic field-free state. In order to show that no bias magnetic field is applied, the bias magnetic field application means 18 is shown with a broken line.

FIG. 4 is a pattern diagram showing a relationship between the magnetic field intensity and the signal output to be applied to the first and second magnetic layers. The horizontal axis and the vertical axis of the graph indicate the magnetic field intensity and the signal output, respectively. Furthermore, in each of FIGS. 3A to 3D, an outline arrow indicates the magnetization direction in each magnetic layer.

The magnetization on the surface of the first antiferromagnetic layer 12 at the side of the first ECMF application layer 13 and the magnetization on the surface of the second antiferromagnetic layer 15 at the side of the second exchange coupling magnetic field application layer 14 are oriented toward the same direction in advance (the left direction in the diagram). Therefore, the first ECMF application layer 13 is magnetized to the right side in the diagram due to the exchange coupling with the first antiferromagnetic layer 12. Similarly, the second exchange coupling magnetic field application layer 14 is magnetized to the right side in the diagram due to the exchange coupling with the second antiferromagnetic layer 15.

The first magnetic linkage layer 5 has a layered structure with the Ru layer 5a, the CoFe layer 5b, the Ru layer 5c, the CoFe layer 5d and the Ru layer 5e. The CoFe layer 5b and the ECMF application layer 13 are exchange-coupled via the Ru layer 5a. It is known that the exchange coupling intensity of Ru depends upon the thickness and indicates a positive or negative value, and for example, great negative exchange coupling intensity can be obtained with 0.4 nm, 0.8 nm and 1.7 nm. Herein, the exchange coupling intensity being negative means that the magnetic layers at both sides of the Ru layer are antiferromagnetically coupled. Therefore, setting the thickness of the Ru layer 5a at these values results in the magnetization of the CoFe layer 5b toward the left in the diagram. Similarly, the CoFe layer 5b and the CoFe layer 5d are exchange-coupled via the Ru layer 5c. In addition, the CoFe layer 5d and the first magnetic layer 6 are exchange-coupled via the Ru layer 5e. Setting of the thickness of the Ru layers 5c and 5e, for example, at 0.4 nm, 0.8 nm or 1.7 nm causes the magnetization of the first magnet layer 6 toward the left in the diagram. The same is applied to the magnetization direction of the second antiferromagnetic layer 15, the second exchange coupling magnetic field application layer 14, the second magnetic linkage layer 9 and the second magnetic layer 8. Therefore, in the embodiment of FIG. 3A, the second magnetic layer 8 is magnetized toward the right in the diagram.

The state A in FIG. 4 shows the state of FIG. 3A, and the magnetization direction FL1 of the first magnetic layer 6 and the magnetization direction FL2 of the second magnetic layer 8 are antiparallel to each other in the magnetic field-flee state. It is needless to say, the magnetization direction FL1 of the first magnetic layer 6 and the magnetization direction FL2 of the second magnetic layer 8 do not have to be strictly in antiparallel. These magnetization directions FL1 and FL2 should be rotatable in the reverse direction when a bias magnetic field is applied as described later.

As described above, the first magnetic linkage layer 5 magnetically couples the first ECMF application layer 13 and the first magnetic layer 6. The first ECMF application layer 13 realizes a function to transmit the exchange coupling magnetic field perpendicular to the film surface orthogonal direction P and in parallel with the ABS S to the first magnetic layer 6 via the first magnetic linkage layer 5. Similarly, the second magnetic linkage layer 9 magnetically couples the second ECMF application layer 14 and the second magnetic layer 8. The second ECMF application layer 14 realizes a function to transmit the exchange coupling magnetic field in antiparallel to the direction of the exchange coupling magnetic field transmitted to the first magnetic layer 6 by the first exchange coupling magnetic layer application layer 13 to the second magnetic layer 8. As a result, as shown in FIG. 3A, the first magnetic layer 6 and the second magnetic layer 8 are magnetized in directions antiparallel to each other in the magnetic field-free state.

In actuality, a bias magnetic field is applied to the first magnetic layer 6 and the second magnetic layer 8. Consequently, next, as shown in FIG. 3B, a state where no external magnetic field is applied but only the bias magnetic field is applied is considered. Herein, the bias magnetic field shall be in the direction toward the ABS S. The magnetization directions of the first magnetic layer 6 and the second magnetic layer 8 are influenced by the bias magnetic field to be rotated toward the ABS S, respectively. As a result, the magnetization directions of the first magnetic layer 6 and the second magnetic layer 8 are rotated from the antiparallel state to the parallel state, and the state becomes an initial magnetized state shown as the state B in FIG. 4 (state where only the bias magnetic field is applied). Here, in FIG. 4, regarding the directions of the bias magnetic field and the external magnetic field, the downward direction in the graph is regarded as “positive.”

When the external magnetic field from the recording medium M is applied in the initial magnetized state, a relative angle formed by the magnetization direction of the first magnetic layer 6 and that of the second magnetic layer 8 is increased or decreased according to the direction of the magnetic field. Specifically, as shown in FIG. 3C, when the magnetic field MF1 oriented toward the recording medium M from the ABS S is applied to the MR-stack 2, the magnetization directions of the first magnetic layer 6 and the second magnetic layer 8 are further rotated toward the ABS S. This causes the magnetization directions of the first magnetic layer 6 and the second magnetic layer 8 to become closer to the parallel state C (State D in FIG. 4). As the state becomes closer to parallel, it becomes difficult for electrons supplied from the electrodes (first and second shield layers 3 and 4) to be scattered, and an electric resistance value of the sense current is decreased. In other words, the signal output is decreased. On the other hand, as shown in FIG. 3D, when the magnetic field MF2 oriented toward the ABS S from the recording medium M is applied to the MR-stack 2, the magnetization directions of the first magnetic layer 6 and the second magnetic layer 8 are rotated toward the direction retreating from the ABS S. This causes the magnetization directions of the first magnetic layer 6 and the second magnetic layer 8 to become closer to the antiparallel state (State E in FIG. 4). As the state becomes closer to antiparallel, it becomes easy for electrons supplied from the electrodes to be scattered, and the electric resistance value of the sense current is increased. In other words, the signal output is increased. Consequently, the external magnetic field can be detected by utilizing a change in the relative angle formed by the magnetization directions of the first magnetic layer 6 and the second magnetic layer 8.

In the first and second magnetic linkage layers 5 and 9, since the magnetization directions of the magnetic layers inside are strongly secured due to the exchange coupling, they are unsusceptible to an external magnetic field. Consequently, the magnetization direction of the first magnetic layer 6 and the second magnetic layer 8 are unsusceptible to the fluctuation of the magnetization directions of the first and second magnetic linkage layers 5 and 9. Therefore, the magnetization directions of the first magnetic layer 6 and the second magnetic layer 8 are changed by mainly reacting to the external magnetic field.

In this embodiment, the thickness and shape of the bias magnetic field application means 18 are adjusted so as to have the magnetization directions of the first magnetic layer 6 and the second magnetic layer 8 be almost orthogonal to each other in the state B (initial magnetized state). If the magnetization direction is orthogonal in the initial magnetized state, as it is clear from FIG. 4, the output change (inclination of signal output) relative to the change in the external magnetic field becomes great. Consequently, a great MR-ratio can be obtained; concurrently, an excellent output symmetrical property can be obtained.

Consequently, the first and second magnetic linkage layers 5 and 9 have a function to transmit information regarding the magnetization directions of the first and second ECMF application layers 13 and 14, especially an anisotropic characteristic for the magnetization direction, to the first and second magnetic layers 6 and 8. In addition, the first and second magnetic linkage layers 5 and 9 also have a function to adjust a read gap. A target value of the read gap is determined based upon a line record density to be realized by the thin film magnetic head. In the meantime, the thickness of the first and second magnetic layers 6 and 8 and the nonmagnetic middle layer 7 will be determined according to other various factors. Consequently, the read gap should be adjusted to a desired size using the first and second magnetic linkage layers 5 and 9.

The thickness of the Ru layer forming the first and second magnetic linkage layers 5 and 9 has a small degree of design freedom as described above. Further, in order to strongly secure the magnetization direction of the CoFe layer included in the first and second magnetic linkage layers 5 and 9 relative to the external magnetic field, the thickness of the CoFe layer cannot be so large. Then, when the first and second magnetic linkage layers 5 and 9 need greater thickness, it is desirable to increase the number of laminations of the Ru layer and the CoFe layer.

For example, in this embodiment, the first and second magnetic linkage layers 5 and 9 use a three-layer configuration of the Ru layer/CoFe layer/Ru layer or a five-layer configuration of Ru layer/CoFe layer/Ru layer/CoFe layer/Ru layer. However, the first and second magnetic linkage layers 5 and 9 are not limited to these configurations, but a seven-layer configuration of Ru layer/CoFe layer/Ru layer/CoFe layer/Ru layer/CoFe layer/Ru layer is also usable.

It is preferable to consider the following points on the occasion of setting the layer configuration of the first and second magnetic linkage layers 5 and 9. According to the reason of magnetizing process, it is preferable that the magnetization directions of the ECMF application layers 13 and 14 that are exchange-coupled with the first and second antiferromagnetic layers 12 and 15 are the same. Further, it is desirable that the first magnetic layer 6 and the second magnetic layer 8 sandwich the nonmagnetic middle layer 7 and are magnetized to be antiparallel to each other in the initial magnetized state. In this embodiment, in order to satisfy these conditions, the number of combinations of Ru layer/CoFe layer to be exchange-coupled is adjusted. In other words, if the first magnetic linkage layer 5 has a five-layer configuration of Ru layer/CoFe layer/Ru layer/CoFe layer Ru layer and the second magnetic linkage layer 9 has a three-layer configuration of Ru layer CoFe layer/Ru layer, the first magnetic layer 6 and the second magnetic layer 8 are magnetized antiparallel to each other. The first magnetic linkage layer 5 may have a three-layer configuration of Ru layer/CoFe layer/Ru layer and the second magnetic linkage layer 9 may have a five-layer configuration of Ru layer/CoFe layer/Ru layer/CoFe layer/Ru layer.

If the desired read gap is small, it appears that either the first magnetic linkage layer 5 or the second magnetic linkage layer 9 has a single layer configuration of Ru layer, as well. As a specific embodiment, the first magnetic linkage layer 5 has a three-layer configuration of Ru layer/CoFe layer/Ru layer so as to align the magnetization directions of the first and second ECMF application layers 13 and 14 that face the first and second antiferromagnetic layers 12 and 15 and are exchange coupled with them, and to magnetize the first magnetic layer 6 and the second magnetic layer 8 in antiparallel. Obviously, the first magnetic linkage layer 5 can have a single layer configuration of Ru layer and the second magnetic linkage layer 9 can have a three-layer configuration of Ru layer/CoFe layer/Ru layer.

In addition, if the magnetization directions of the first and second ECMF application layers 13 and 14 that face the first and second antiferromagnetic layers 12 and 15 and are exchange-coupled with them are reversed, it is also possible that the first and second magnetic linkage layers 5 and 9 have a single layer configuration of Ru layer.

Thus, in the thin film magnetic head of the present invention, it is possible to configure to have a magnetic layer (magnetic linkage layer) including at least one layer of Ru layer between the first magnetic layer 6 and the first ECMF application layer 13 and/or between the second magnetic layer 8 and the second ECMF application layer 14. Further, it is also possible to configure to have a magnetic linkage layer formed with a Ru layer between the first magnetic layer 6 and the first ECMF application layer 13 and/or between the second magnetic layer 8 and the second ECMF application layer 14.

Furthermore, in the case of using a plurality of CoFe layers within the first and second magnetic linkage layers 5 and 9, it is desirable that the thickness of each CoFe layer is matched. The CoFe layer is magnetized by the external magnetic field and the magnetization direction tends to be rotated toward the external magnetic field; however, if the thickness of the CoFe layer is different, a thicker CoFe layer overcomes the exchange coupling force and becomes easier to rotate, and there is some possibility to inhibit the function to transmit the information regarding the magnetization direction of the first and second ECMF application layers 13 and 14 to the first and second magnetic layers 6 and 8.

In the thin film magnetic head of this embodiment, the first and second magnetic layers 6 and 8 whose magnetization direction is changed according to an external magnetic field are magnetized in antiparallel to each other in the magnetic field-flee state by the exchange coupling magnetic field from the first and second ECMF application layers 13 and 14 to be transmitted via the first and second magnetic linkage layers 5 and 9. Therefore, as the nonmagnetic middle layer 7, it is unnecessary to use a material that generates an RKKY interaction between the first magnetic layer 6 and the second magnetic layer. Consequently, it becomes possible to appropriately use a material that can maximize a magnetoresistant effect as the nonmagnetic middle layer 7, and therefore a high MR-ratio can be obtained.

Further, since the first and second ECMF application layers 13 and 14 are strongly magnetized by the first and second antiferromagnetic layers 12 and 15, the magnetized state of the first and second magnetic layers 6 and 8 can be easily controlled. Thus, thin film magnetic heads do not vary greatly and a high MR-ratio can be obtained.

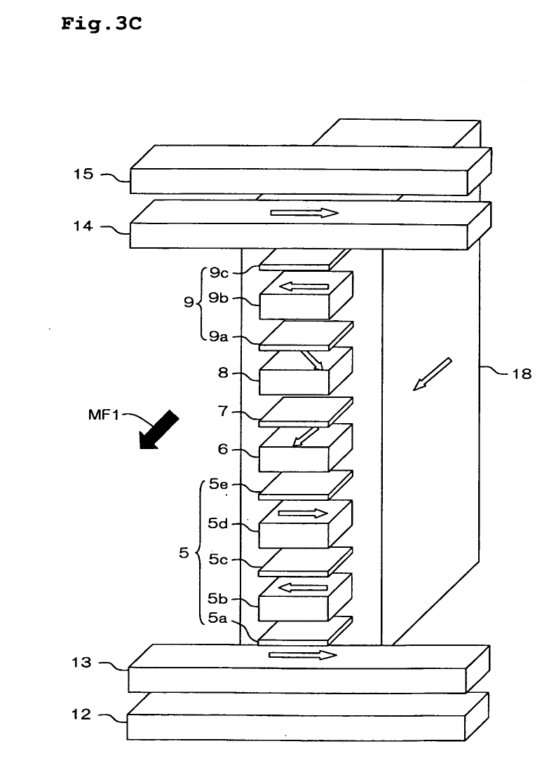

FIG. 5 shows a modified embodiment of the present invention. In the film configuration in this modified embodiment, the film configurations of a first ECMF application layer 13 and a second exchange coupling magnetic field (ECMF) application layer 54 are different from those shown in Table 1. The film configuration of this modified embodiment is shown in Table 2. In Table 2, the film configurations are described from bottom to top in lamination order from the first shield layer 3 toward the second shield layer 4.

The first ECMF application layer 13 has a first ferromagnetic layer 13a disposed in a manner of facing the first magnetic linkage layer 5 and a second ferromagnetic layer 13b disposed in a manner of facing the first antiferromagnetic layer 12. In addition, the first ECMF application layer 13 has an amorphous layer 13c sandwiched between the first ferromagnetic layer 13a and the second ferromagnetic layer 13b. In this embodiment, the second ferromagnetic layer 13b has a two-layer configuration of CoFe/NiFe.

TABLE 2

| | | | | Thickness | Magnetization |
|---|---|---|---|---|---|
| Layer configuration | | | | [nm] | direction |
| Second | Second main shield layer 16 | | NiFe layer | 1000 | |
| shield | Second antiferromagnetic layer 15 | | IrMn layer | 5 | |
| layer 4 | Second ECMF | Fourth | CoFe layer | 1 | → |
| | application | ferromagnetic layer | NiFe layer | 1 | |
| | layer 54 | 54b | | | |
| | | Amorphous layer | CoFeB layer | 1 | |
| | | 54c | | | |
| | | Third ferromagnetic | NiFe layer | 2 | |
| | | layer 54a | | | |
| MR-stack 2 | Second magnetic linkage layer 9 | | Ru layer 9c | 0.8 | |
| | | | CoFe layer | 1 | ← |
| | | | 9b | | |
| | | | Ru layer 9a | 0.8 | |
| | Second magnetic layer 8 | | CoFe layer | 4 | → |
| | Nonmagnetic middle layer 7 | | ZnO layer | 2 | |
| | First magnetic layer 6 | | CoFe layer | 4 | ← |
| | First magnetic linkage layer 5 | | Ru layer 5e | 0.8 | |
| | | | CoFe layer | 1 | → |
| | | | 5d | | |
| | | | Ru layer 5c | 0.8 | |
| | | | CoFe layer | 1 | ← |
| | | | 5b | | |
| | | | Ru layer 5a | 0.8 | |
| First shield | First ECMF | First ferromagnetic | NiFe layer | 2 | → |
| layer 3 | application | layer 13a | | | |
| | layer 13 | Amorphous layer | CoFeB layer | 1 | |
| | | 13c | | | |
| | | Second | NiFe layer | 1 | |
| | | ferromagnetic layer | CoFe layer | 1 | |
| | | 13b | | | |

| | | |
|---|---|---|
| First antiferromagnetic layer 12 | IrMn layer | 5 |
| First main shield layer 11 | NiFe layer | 1000 |

Further, the second ECMF application layer 54 has a third ferromagnetic layer 54a facing the second magnetic linkage layer 9 and a fourth ferromagnetic layer 54b facing the second ferromagnetic layer 15. In addition, the second ECMF application layer 54 has an amorphous layer 54c sandwiched between the third ferromagnetic layer 54a and the fourth ferromagnetic layer 54b. Thus, the second ECMF application layer 54 may include the amorphous layer 54c. As a result, the film configuration and thickness of the first ECMF application layer 13 and the second ECMF application layer 54 can be matched.

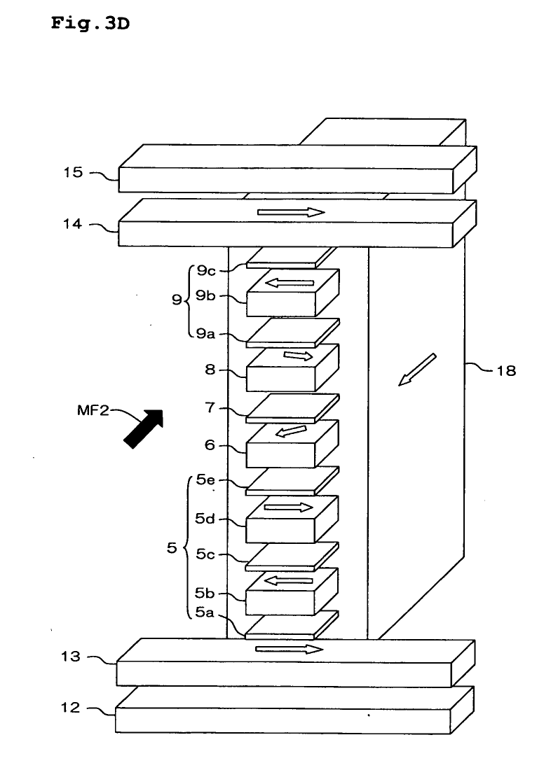

Further, in FIG. 6, another modified embodiment of the present invention is shown. With reference to FIG. 6, in the film configuration of this modified embodiment, compared to the film configuration shown in Table 1, the configuration of the first ECMF application layer is different. In this modified embodiment, a first exchange coupling magnetic field application layer (hereinafter, first ECMF application layer) 63 has two amorphous layers 63c and 63e. As the amorphous layers 63c and 63e, CoFeB or CoZrTa can be used. Specifically, the first ECMF application layer 63 has a first ferromagnetic layer 63a disposed facing the first magnetic linkage layer 5 and the second ferromagnetic layer 63b disposed facing the first antiferromagnetic layer 12. In addition, the first ECMF application layer 63 has two amorphous layers 63c and 63e sandwiched between the first ferromagnetic 63a and the second ferromagnetic 63b. Another ferromagnetic layer 63d is disposed between the two amorphous layers 63c and 63e. NiFe can be used as this ferromagnetic layer 63d. Thus, the lamination of the two amorphous layers 63c and 63e allows further reducing the surface roughness of each layer of the MR-stack 2.

In addition, the first exchange coupling magnetic layer may have three or more layers of amorphous layers. In this case, a ferromagnetic layer is disposed between the respective amorphous layers. Thus, control of the number of layered amorphous layers allows controlling a total of thickness of the MR-stack, the first shield layer and the second shield layer.

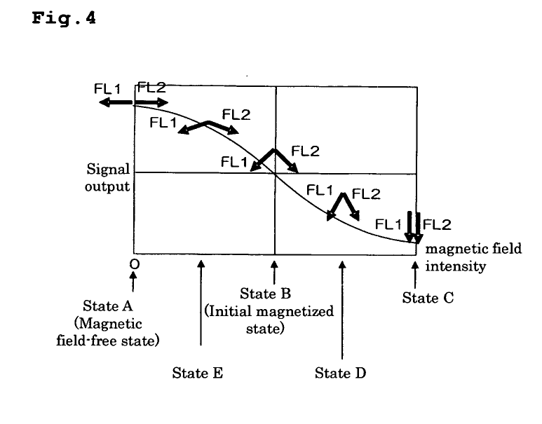

FIG. 7 shows another modified embodiment. As shown in FIG. 7, a synthetic exchange coupling magnetic field (ECMF) application layer 41 may be used instead of the second ECMF application layer 14 shown in Table 1. The synthetic ECMF application layer 41 has a pair of ferromagnetic layers 41a and 41c that are antiferromagnetically coupled via a nonmagnetic conductive layer 41b made of Ru or the like. The ferromagnetic layers 41a and 41c are formed with a CoFe layer and a NiFe layer, and, a layered structure with a CoFe layer and a NiFe layer. In the case of using a Ru layer as the nonmagnetic conductive layer 41b, it is preferable that thickness of Ru layer is approximately 0.8 nm.

If the synthetic ECMF application layer 41 is used, the magnetization direction is inverted once within the second shield layer 4. Consequently, the first and second magnetic linkage layers 5 and 9 may have a three-layer configuration of Ru layer/CoFe layer/Ru layer. As a result, the film configuration and thickness of the first magnetic linkage layer 5 and the second magnetic linkage layer 9 can be matched. Further, as it is clear from the comparison between FIG. 3A and FIG. 7, the thickness of the first magnetic linkage layer 5 is decreased. Therefore, the read gap is reduced and high recording density can be further realized.

In FIG. 7, the synthetic ECMF application layer 41 is used instead of the second ECMF application layer 14; however, a synthetic ECMF application layer may be used instead of the first ECMF application layer 13. In this case, an amorphous layer should be disposed within the synthetic ECMF application layer.

Further, the thin film magnetic head may have a film configuration combining these typical modified embodiments.

The thin film magnetic head 1 of this embodiment can be produced using the method mentioned below. First, the first shield layer 3 is formed on a substrate 91 (see FIG. 1), and next, each layer constituting the MR-stack 2 is formed on the first shield layer 3 using sputtering. Furthermore, at least one layer within the first shield layer 3 should be an amorphous layer. Thus, the surface roughness of each layer layered after the deposition of the amorphous layer is reduced.

Next, each of these layers is patterned and both sides in the track width direction T are filled with an insulating film 17. Then, milling is conducted from the ABS S by leaving a portion equivalent to height h of the element (see FIG. 1), and the bias magnetic field application means 18 is formed via the insulating layer 19. As described above, the insulating layer 17 is formed on both sides in the track width direction T of the MR-stack 2, and the bias magnetic field application means 18 is formed on the rear side of the MR-stack 2 viewed from the ABS S. After that, the second shield layer 4 is formed. In addition, the above-mentioned writing part 20 is produced with a well-known technique.

### Embodiment

The first shield layer 3 with 1 μm of thickness was formed on an ALTiC(Al₂O₃—TiC) substrate using a DC magnetron sputtering device, and a buffer layer formed with a Ta layer and a Ru layer was formed. Then, an IrMn alloy, which is an antiferromagnetic material, was deposited at 5 nm of thickness to form the first antiferromagnetic layer 12. Subsequently, the first ECMF application layer 13 was formed on the first antiferromagnetic layer 12. Subsequently, a Ru layer with 0.8 nm of thickness, a CoFe alloy with 1 nm of thickness, the Ru layer with 0.8 nm of thickness, the CoFe alloy with 1 nm of thickness and the Ru layer with 0.8 nm of thickness were deposited onto the first ECMF application layer 13 in respective order to form the first magnetic linkage layer 5. The first magnetic layer 6 with 4 nm of thickness, the nonmagnetic middle layer made of ZnO with 2 nm of thickness and the second magnetic layer 8 with 4 nm of thickness were deposited on the first magnetic linkage layer 5 in respective order. After that, the Ru layer with 0.8 nm of thickness, a CoFe alloy with 1 nm of thickness and the Ru layer with 0.8 nm of thickness were deposited in respective order to form the second magnetic linkage layer 9, and milling was conducted to have a reproducing head shape. In addition, a NiFe alloy and a CoFe alloy were deposited in respective order to form the second ECMF application layer 14. The IrMn alloy with 5 nm of thickness was deposited thereon to form the second antiferromagnetic layer 15. After a Cu layer with 1 nm of thickness was deposited thereon, the NiFe alloy with 1 μm of thickness was deposited to form the second shield layer 4. After that, the obtained layers were annealed in the magnetic field at 250° C. for three hours to make samples of reproducing head (Embodiments 1-14).

In Embodiments 1-8, a three-layer configuration of CoFe alloy/CoFeB alloy/NiFe alloy using thickness as a parameter, a three-layer configuration of NiFe alloy/CoFeB alloy/NiFe alloy using thickness as a parameter or a four-layer configuration of CoFe alloy/NiFe alloy/CoFeB alloy/NiFe alloy was used as the first ECMF application layer 13. Herein, the CoFeB alloy is an amorphous layer.

Further, as Comparative Embodiments 1-3, samples with a configuration having the first ECMF application layer not including an amorphous layer were also produced instead of the first ECMF application layer 13 in this embodiment.

The film configuration or film thickness of the first ECMF application layer, surface roughness of the nonmagnetic middle layer 7 and a MR-ratio of the test samples obtained as mentioned above are shown in Table 3. In this embodiment, arithmetic mean roughness (Ra) was measured as surface roughness. The arithmetic mean roughness was obtained by measuring the surface of the nonmagnetic middle layer 7 with an atomic force microscope (AFM) in the state where layers were layered up to the nonmagnetic middle layer 7. Furthermore, it is more preferable that the MR-ratio is higher. In Table 3, the film configuration is described from left to right in layered order from the first antiferromagnetic layer 12 toward the first magnetic linkage layer 5.

TABLE 3

| | First ECMF application layer | | | | | | | |
|---|---|---|---|---|---|---|---|---|
| | Second | | | | | | | |
| | ferromagnetic | | | First | | | | |
| | layer | | Amorphous | ferromagnetic | | | Surface | |
| | CoFe | NiFe | layer | layer | Total | | roughness | |
| | layer | layer | CoFeB | NiFe layer | thickness | Thickness | {Ra} | MR-ratio |
| | [nm] | [nm] | layer [nm] | [nm] | [nm] | ratio | [nm] | [%] |
| Comparative | 1 | 0 | 0 | 4 | 5 | 0.00 | 0.42 | 16.0 |
| Embodiment 1 | | | | | | | | |
| Comparative | 1 | 0 | 0 | 29 | 30 | 0.00 | 0.70 | 13.2 |
| Embodiment 2 | | | | | | | | |
| Comparative | 1 | 0 | 0 | 79 | 80 | 0.00 | 1.02 | 12.3 |
| Embodiment 3 | | | | | | | | |
| Comparative | 3 | 2 | 5 | 110 | 120 | 0.05 | 0.83 | 14.8 |
| Embodiment 4 | | | | | | | | |
| Comparative | 1 | 10 | 2 | 107 | 120 | 0.02 | 0.90 | 14.1 |
| Embodiment 5 | | | | | | | | |
| Embodiment 1 | 0 | 2 | 1 | 2 | 5 | 0.50 | 0.32 | 19.1 |
| Embodiment 2 | 1 | 1 | 1 | 2 | 5 | 0.50 | 0.30 | 20.1 |
| Embodiment 3 | 1 | 5 | 3 | 21 | 30 | 0.14 | 0.29 | 20.4 |
| Embodiment 4 | 1 | 5 | 5 | 19 | 30 | 0.26 | 0.24 | 21.3 |
| Embodiment 5 | 1 | 5 | 15 | 9 | 30 | 1.67 | 0.21 | 22.2 |
| Embodiment 6 | 0 | 5 | 5 | 70 | 80 | 0.07 | 0.33 | 17.7 |
| Embodiment 7 | 1 | 10 | 10 | 59 | 80 | 0.17 | 0.28 | 19.1 |
| Embodiment 8 | 1 | 0 | 10 | 69 | 80 | 0.14 | 0.28 | 18.0 |

In Comparative Embodiment 1, results of the surface roughness and the MR-ratio in the thin film magnetic head not having an amorphous layer (CoFeB alloy layer) are shown. Therefore, if the MR-ratio is greater than that in Comparative Embodiment 1, it indicates that the thin film magnetic head is effective.

With reference to Table 3, the MR-ratio is improved in the thin film magnetic heads in Embodiments 1-8. In particular, according to the comparison between the samples with the same thickness (comparison between Comparative Embodiment 1 and Embodiments 1 and 2; comparison between Comparative Embodiment 2 and Embodiments 3-5; and comparison between Comparative Embodiment 3 and Embodiments 6-8), due to the amorphous layer (CoFeB alloy layer), it is obvious that the surface roughness of the nonmagnetic middle layer 7 is reduced and the rate or MR change is improved.

In this configuration, a NiFe layer, which is the first ferromagnetic layer, is disposed between the MR-stack 2 and the amorphous layer. If the thickness of the amorphous layer is sufficient, the surface roughness of the first ferromagnetic layer is sufficiently reduced, and the surface roughness of each layer in the MR-stack to be layered on the first ferromagnetic layer is reduced. On the other hand, when the thickness of the first ferromagnetic layer is increased, the surface roughness is increased. It appears that this is attributable to the crystal growth. Therefore, it appears that the ratio of the thickness of the amorphous layer to the thickness of the first ferromagnetic layer is an important factor. Values (thickness ratio) where the thickness of the amorphous layer is divided by the thickness of the first ferromagnetic layer are shown in Table 3, as well.

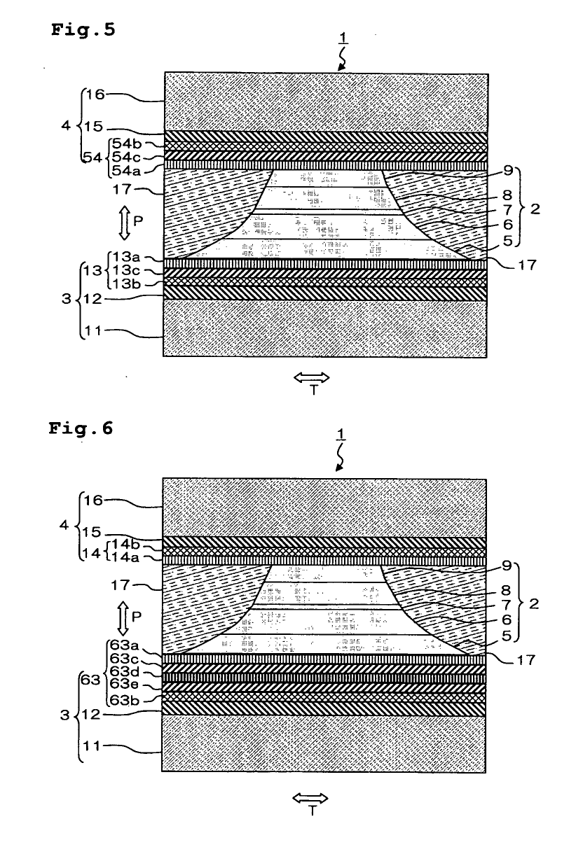

FIG. 8 is a graph showing a relationship between the ratio of the thickness of the amorphous layer to that of the first ferromagnetic layer and the MR-ratio. With reference to this graph, there is a correlation between the thickness ratio and the MR-ratio, and it is clear that the greater the thickness ratio becomes, the more the MR-ratio is improved. Then, when the thickness ratio is 0.07 or more, the MR-ratio becomes greater than that obtained in Comparative Embodiment 1. Therefore, it is preferable that the thickness ratio is 0.07 or greater.

Table 4 shows the measurement results in the case that the amorphous layer of the first ECMF application layer is a CoZrTa layer as Embodiment 9. The configuration other than the amorphous layer is the same as that of the above-mentioned embodiments. Further, by comparing Table 4 with the measurement results in the embodiments whose total thickness is the same (Comparative Embodiment 3 and Embodiment 7), it is clear that, even when the amorphous layer is a CoZrTa layer, the surface roughness of the nonmagnetic middle layer 7 is reduced and the MR-ratio is improved.

TABLE 4

| | First ECMF application layer | | | | | | | |
|---|---|---|---|---|---|---|---|---|
| | Second | | | | | | | |
| | ferromagnetic | | Amorphous | First | | | | |
| | layer | | layer | ferromagnetic | | | Surface | Rate or |
| | | NiFe | CoZrTa | layer | Total | | roughness | MR |
| | CoFe | layer | layer | NiFe layer | thickness | Thickness | {Ra} | change |
| | [nm] | [nm] | [nm] | [nm] | [nm] | ratio | [nm] | [%] |
| Embodiment 9 | 1 | 10 | 10 | 59 | 80 | 0.17 | 0.28 | 17.9 |

Next, values for the surface roughness and the MR-ratio of the nonmagnetic middle layer 7 in Embodiments 10-14 where the layer configuration of the first ECMF application layer was changed were measured, and the results are shown in Table 5. Furthermore, the layer configuration other than the first ECMF application layer is the same as that in Embodiments 1-8. In the film configuration shown in Table 5, the CoFeB layer is an amorphous layer. The amorphous layer (CoFeB layer) is sandwiched by the NiFe layers, which are the ferromagnetic layers. Furthermore, in Table 5, results in Comparative Embodiments 1-3 and Embodiment 7 shown in Table 3 are shown as comparison.

TABLE 5

| | Exchange coupling magnetic field (ECMF) application layer | | | | | | | | | | | | |
|---|---|---|---|---|---|---|---|---|---|---|---|---|---|
| | | | | | | | | | | First | | | |
| | Second FL | | AL | FL | AL | FL | AL | FL | AL | FL | | SR | |
| | CoFe | NiFe | CoFeB | NiFe | CoFeB | NiFe | CoFeB | NiFe | CoFeB | NiFe | TT | (Ra) | MR R |
| | [nm] | [nm] | [nm] | [nm] | [nm] | [nm] | [nm] | [nm] | [nm] | [nm] | [nm] | [nm] | [%] |
| CE 1 | 1 | | | | | | | | | 4 | 5 | 0.42 | 16.0 |
| CE 2 | 1 | | | | | | | | | 29 | 30 | 0.70 | 13.2 |
| CE 3 | 1 | | | | | | | | | 79 | 80 | 1.02 | 12.3 |
| E 7 | 1 | | | | | | | 10 | 10 | 59 | 80 | 0.28 | 19.1 |
| E 10 | 1 | | | | | 3 | 2 | 3 | 2 | 4 | 15 | 0.21 | 20.5 |
| E 11 | 1 | | | | | 6 | 5 | 7 | 5 | 6 | 30 | 0.22 | 21.5 |
| E 12 | 1 | | | | | 10 | 5 | 39 | 5 | 20 | 80 | 0.24 | 20.6 |
| E 13 | 1 | | | 10 | 3 | 20 | 3 | 19 | 4 | 20 | 80 | 0.25 | 20.1 |
| E 14 | 1 | 10 | 2 | 13 | 2 | 13 | 3 | 13 | 3 | 20 | 80 | 0.26 | 19.9 |

Note:
Above Abbreviations represent followings:
CE: Comparative Embodiment
E: Embodiment
AL: Amorphous layer
FL: Ferromagnetic layer
TT: Total Thickness
SR: Surface roughness
MR R: MR-ratio

With reference to Table 5, in the layer configuration having a plurality of amorphous layers, the MR-ratio is improved compared to the thin film magnetic heads (Comparative Embodiments 1-3) with the configuration not having an amorphous layer. Further, compared to Embodiment 7 whose total thickness of the first ECMF application layer is the same, the MR-ratio is further improved in the thin film magnetic head with a film configuration having a plurality of amorphous layers. Thus, if a plurality of amorphous layers are disposed and the surface of the nonmagnetic middle layer 7 is sufficiently leveled, the MR-ratio is further improved.

As explained above, since the thin film magnetic heads in this embodiment and the abovementioned embodiments have the first ECMF application layer 13 including an amorphous layer, the surface roughness of each layer in the MR-stack layered on the amorphous layer, especially the surface roughness of the nonmagnetic middle layer 7, is reduced. As a result, the MR-ratio of the thin film magnetic head 1 is improved.

In addition, since the first and second ECMF application layers realize the functions as the shield layers 3 and 4, they also contribute to the reduction of the read gap. In other words, the first and second ECMF application layers and the first and second antiferromagnetic layers 12 and 15 combine the function as a magnetization control layer to control the magnetized state of the first and second magnetic layers 6 and 8 and the function as the shield layers.

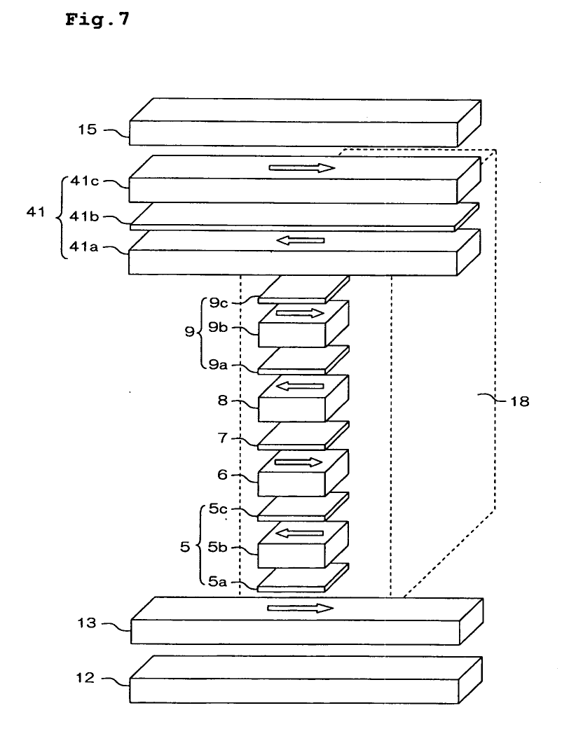

Next, a wafer used for the production of the thin film magnetic head will be described. With reference to FIG. 9, a layered body constituting at least a thin film magnetic head is formed on a wafer 100. The wafer 100 is divided into a plurality of bars 101, which are a work unit on the occasion of polish processing of ABS S. The bars 101 are further cut after the polish processing, and are separated into a slider 210 including a thin film magnetic head. Margins (not shown) are disposed to the wafer 100 for the purpose of cutting the wafer 100 into the bars 101 and the bars 101 into the slider 210.

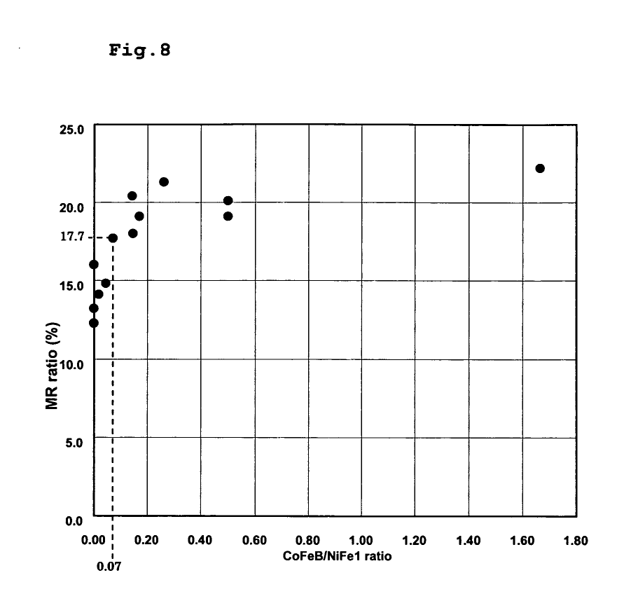

With reference to FIG. 10, the slider 210 has substantially a hexahedron shape, one surface of which is the ABS S opposite to the hard disk.

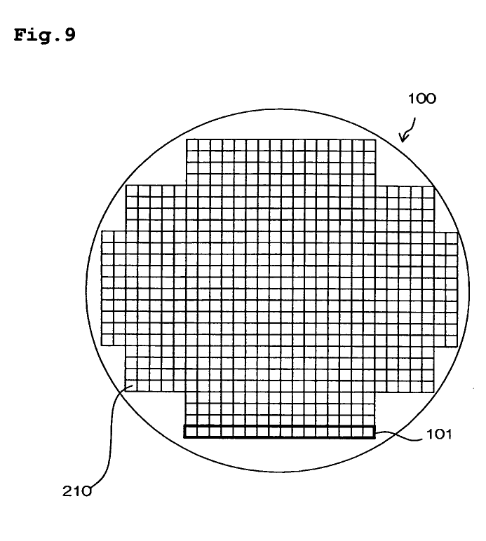

With reference to FIG. 11, a head gimbal assembly 220 is equipped with the slider 210 and a suspension 221 elastically supporting the slider 210. The suspension 221 has a leaf spring-state load beam 222 formed from stainless steel, a flexure 223 disposed at one end of the load beam 222 and a base plate 224 at the other end of the load beam 222. The flexure 223 is joined with the slider 210, and provides an appropriate degree of freedom to the slider 210. A gimbal part for maintaining the position of the slider 210 to be constant is disposed in a portion of the flexure 223 where the slider 210 is mounted.

The slider 210 is arranged within the hard disk drive so as to be opposite to the hard disk, which is a disc recording medium to be rotated and driven. When the hard disk is rotated toward the z direction in FIG. 11, lift force downward in the y direction is generated to the slider 210 due to an air flow passing between the hard disk and the slider 210. The slider 210 is designed to float from the surface of the hard disk due to this lift force. The thin film magnetic head 1 is formed in the vicinity of the end on the air flow side of the slider 210 (end in the lower left in FIG. 10).

The head gimbal assembly 220 mounted to the arm 230 is referred to as a head arm assembly. The arm 230 moves the slider 210 to the track transverse direction x of the hard disk 262. One end of the arm 230 is mounted to the base plate 224. A coil 231, which is a portion of the voice coil motor, is mounted to the other end of the arm 230. A bearing 233 is disposed in the intermediate part of the arm 230. The arm 230 is rotatably supported by a shaft 234 mounted to the bearing 233. The arm 230 and the voice coil motor driving the arm 230 constitute an actuator.

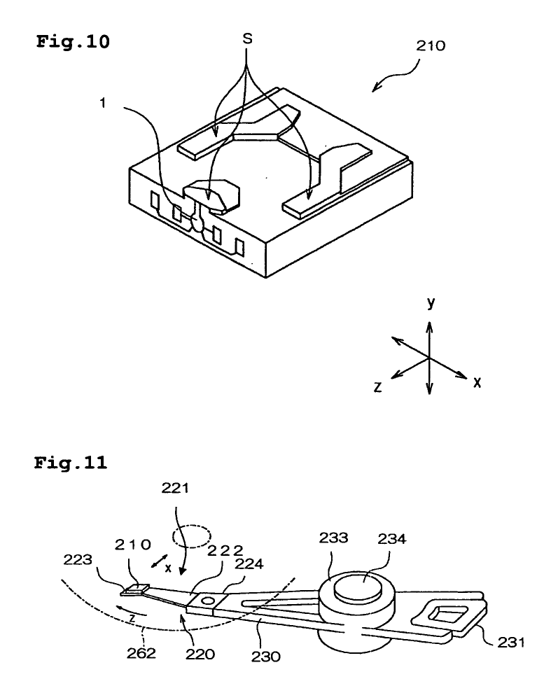

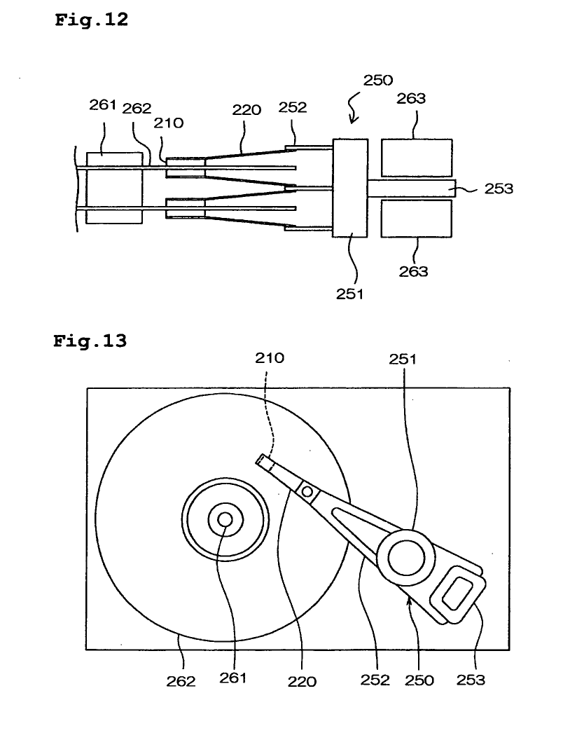

Next, with reference to FIG. 12 and FIG. 13, a head stack assembly where the slider 210 is incorporated and a hard disk drive will be described. The head stack assembly is an assembly where the head gimbal assembly 220 is mounted to each arm 252 in a carriage 251 having a plurality of arms 252. FIG. 12 is a side view of the head stack assembly, and FIG. 13 is a plan view of the hard disk drive. The head stack assembly 250 has the carriage 251 having a plurality of arms 252. The head gimbal assemblies 220 are mounted to each arm 252 in such a way that they are spaced at certain intervals and perpendicularly aligned with each other. The coil 253, which is a portion of the voice coil motor, is mounted to the opposite side from the arm 252 in the carriage 251. The voice coil motor has permanent magnets 263 to be opposite from each other via the coil 253.

With reference to FIG. 13, the head stack assembly 250 is incorporated into the hard disk drive. The hard disk drive has a plurality of hard disks 262 mounted to a spindle motor 261. Two sliders 210 are disposed so as to be opposite to each other across the hard disks 262. The head stack assembly 250 except for the slider 210 and the actuator correspond to a positioning device in the present invention, and support the slider 210; concurrently, position the slider 210 to the hard disk 262. The slider 210 is moved in the track transverse direction of the hard disk 262 by the actuator, and is positioned with regard to the hard disk 262. The thin film magnetic head 1 included in the slider 210 records information in the hard disk 262 by the recording head, and reproduces information recorded in the hard disk 262 by the reading part of the reproducing head.

The desirable embodiments of the present invention were proposed and described in detail, and it should be understood that the present invention is variously modifiable and correctable without departing from the spirit or scope of the attached claims.

What is claimed is:

1. A thin film magnetic head comprising:
a magnetoresistance (MR) layered body that has a first magnetic layer whose magnetization direction is changed according to an external magnetic field, a nonmagnetic middle layer and a second magnetic layer whose magnetization direction is changed according to an external magnetic field, and where the first magnetic layer, the nonmagnetic middle layer and the second magnetic layer are disposed in a manner of facing each other in respective order;
first and second shield layers that are disposed in a manner of sandwiching the MR-stack in the film surface orthogonal direction of the MR-stack facing the first magnetic layer and the second magnetic layer, respectively, and that also serve as an electrode for applying a sense current to the film surface orthogonal direction of the MR-stack; and
a bias magnetic field application means that is disposed on an opposite surface of an air bearing surface (ABS) of the MR-stack, and that applies a bias magnetic field to the MR-stack in the direction orthogonal to the ABS, wherein
the first shield layer has
a first exchange coupling magnetic field (ECMF) application layer that is disposed in a manner of facing the first magnetic layer, and that transmits to the first magnetic layer an exchange coupling magnetic field in the direction in parallel with the ABS, and that includes an amorphous layer, and
a first antiferromagnetic layer that is disposed on a rear surface of the first ECMF application layer viewed from the first magnetic layer in a manner of facing the first ECMF application layer, and that is exchange-coupled with the first ECMF application layer, and
the second shield layer has
a second exchange coupling magnetic field (ECMF) application layer that is disposed in a manner of facing the second magnetic layer, and that transmits to the second magnetic layer the exchange coupling magnetic field in a direction in parallel with the ABS, and
a second antiferromagnetic layer that is disposed on a rear surface of the second ECMF application layer viewed from the second magnetic layer, and that is exchange-coupled with the second ECMF application layer.

2. The thin film magnetic head according to claim 1, wherein
a magnetization direction of the first magnetic layer and that of the second magnetic layer are antiparallel with each other in the state with no bias magnetic field and no external magnetic field.

3. The thin film magnetic head according to claim 1, wherein
the first ECMF application layer comprises:
a first ferromagnetic layer that faces the MR-stack; and
a second ferromagnetic layer that faces the first antiferromagnetic layer, and that is exchange-coupled with the first antiferromagnetic layer.

4. The thin film magnetic head according to claim 3, wherein
a value where the thickness of the amorphous layer is divided by the thickness of the first ferromagnetic layer is 0.07 or greater.

5. The thin film magnetic head according to claim 1, wherein
the amorphous layer contains CoFeB or CoZrTa.

6. The thin film magnetic head according to claim 1, where
a plurality of amorphous layers are included in the first ECMF application layer.

7. The thin film magnetic head according to claim 1, wherein
the second ECMF application layer includes an amorphous layer.

8. The thin film magnetic head according to claim 1, wherein
each of the first and second antiferromagnetic layers includes at least one selected from the group consisting of Fe—Mn alloy, Ni—Mn alloy, Ir—Mn alloy and Pt—Mn alloy.

9. The thin film magnetic head according to claim 1, wherein
each of the first and second ECMF application layers contains a CoFe alloy layer facing the first or second antiferromagnetic layers.

10. The thin film magnetic head according to claim 1, wherein
either the first or second ECMF application layer contains a pair of ferromagnetic layers that are antiferromagnetically coupled via a nonmagnetic conductive layer.

11. The thin film magnetic head according to claim 1, wherein
the MR-stack comprises a first magnetic linkage layer, which is formed from multilayer films including at least a magnetic layer comprised of ruthenium (Ru), at least either between the first magnetic layer and the first ECMF application layer or between the second magnetic layer and the second ECMF application layer.

12. The thin film magnetic head according to claim 1, wherein
the MR-stack comprises a first magnetic linkage layer formed from a Ru layer between the first magnetic layer and the first ECMF application layer and/or between the second magnetic layer and the second ECMF application layer.

13. A slider comprising the thin film magnetic head according to claim 1.

14. A wafer where a layered body to be the thin film magnetic head according to claim 1 is formed.

15. A head gimbal assembly, comprising the slider according to claim 13, and a suspension elastically supporting the slider.

16. A hard disk drive, comprising the slider according to claim 13, and a positioning device supporting the slider for concurrently positioning the slider to a recording medium.
